(19) United States
(12) Patent Application Publication
(10) Pub. No.: US 2026/0043776 A1
(43) Pub. Date: Feb. 12, 2026

(54) TEST DEVICE AND TEST METHOD

(71) Applicant: JGC JAPAN CORPORATION, Kanagawa (JP)

(72) Inventor: Naoya OSHIMA, Kanagawa (JP)

(73) Assignee: JGC JAPAN CORPORATION, Kanagawa (JP)

(21) Appl. No.: 18/995,833

(22) PCT Filed: Nov. 8, 2023
(86) PCT No.: PCT/JP2023/040281

§ 371 Date: Jan. 17, 2025

(30) Foreign Application Priority Data
Dec. 23, 2022 (JP) 2022-206253

(51) Int. Cl. G01N 31/10

(52) U.S. Cl. CPC G01N 31/10

(57) ABSTRACT

Provided are a test device and a test method. In the test device, sample feeders feed samples to a catalyst at a preset flow rate, and each of multiple reaction vessels includes a catalyst layer filled with the catalyst. Feed side switching valves connect a feed flow path through which the samples are fed, to a feed destination reaction vessel, and an outflow side switching valve connects a sample flow path intended to collect the samples for analysis, to an outflow source reaction vessel through which the sample flows out of the catalyst layer. A control unit performs a switching control of the feed destination reaction vessel and the outflow source reaction vessel with the feed side switching valves and the outflow side switching valve, such that a reaction rate test is performed under at least three conditions having different residence times in the catalyst layer.

### TECHNICAL FIELD

The present invention relates to a technique for conducting a test intended to determine a reaction rate of a chemical reaction that proceeds in the presence of a catalyst.

### BACKGROUND ART

In designing a reactor that feeds a raw material to a catalyst layer filled with a solid catalyst and obtains a desired target component, it is necessary to determine a reaction rate of a reaction (catalytic reaction) using that catalyst. However, in order to determine a precise reaction rate while avoiding a change in fluidized state in the catalyst layer, it is required to repeatedly conduct the reaction rate test while replacing a plurality of reaction vessels having different volumes of the catalyst layer with one another. Measurement of the reaction rate of the catalytic reaction involving such replacement of reaction vessels has put a heavy work burden on a test conductor.

Here, Patent Literature 1 describes a technique of feeding the same amount of test fluid per unit time to a vessel accommodating a catalyst, when conducting screening in which a reactant is caused to react in the presence of a catalyst by a combinatorial library approach. In addition, Patent Literature 2 describes a reaction analysis device that acquires a temperature distribution of a reaction fluid along a flow direction of the reaction fluid flowing through a flow reactor immediately after the start of a reaction and specifies a reaction state of the reaction fluid.

However, neither of Patent Literatures 1 nor 2 discloses a technique for measuring a reaction rate using a plurality of reaction vessels having different volumes of the catalyst layer.

### CITATION LIST

### Patent Literature

Patent Literature 1: US 2002/0141900 A
Patent Literature 2: JP 2021-159910 A

### SUMMARY OF INVENTION

### Technical Problem

The present invention has been made under such a background and provides a technique for automatically conducting a reaction rate test while changing a residence time in a catalyst layer under conditions with a same fluidized state.

### Solution to Problem

The present invention provides a test device that performs a reaction rate test of a chemical reaction that proceeds in a presence of a catalyst, the test device including:
a sample feeder that feeds a sample to be fed to the catalyst at a preset flow rate;
a plurality of reaction vessels each including a catalyst layer filled with the catalyst;
a temperature adjusting mechanism that adjusts a temperature of the reaction vessels;
a feed side switching valve that connects a feed flow path through which the sample is fed from the sample feeder, to a feed destination reaction vessel selected from the plurality of reaction vessels;
an outflow side switching valve that connects a sample flow path intended to collect the sample for analysis that has passed through the catalyst layer, to an outflow source reaction vessel from which the sample flows out of the catalyst layer; and
a control unit that performs switching control of the feed destination and outflow source reaction vessels with the feed side switching valve and the outflow side switching valve such that the reaction rate test is performed under at least three conditions having different residence times in the catalyst layer.

The test device may have the following features.
(a) At least three reaction vessels having different volumes of the catalyst layer from each other are provided, in which the control unit performs the switching control such that the feed destination reaction vessel and the outflow source reaction vessel coincide with each other.
(b) The temperature adjusting mechanism is configured to adjust the temperature while the reaction vessels are in an accommodated state inside a temperature adjusting chamber, and further provided are: an upstream side temperature adjusting chamber and a downstream side temperature adjusting chamber each accommodating a plurality of the reaction vessels having different volumes of the catalyst layer from each other; and an intermediate switching valve that connects an upstream side reaction vessel that is accommodated in the upstream side temperature adjusting chamber and through which the sample flows out of the catalyst layer, and a downstream side reaction vessel that is selected from the plurality of the reaction vessels accommodated in the downstream side temperature adjusting chamber and to which the sample flowing out of the upstream side reaction vessel is fed, in which the control unit performs a connection control between the upstream side reaction vessel and the downstream side reaction vessel with the intermediate switching valve, in addition to the switching control of the reaction vessels.
(c) The temperature adjusting mechanism is configured to adjust the temperature while a plurality of the reaction vessels having different volumes of the catalyst layer from each other is in an accommodated state inside a temperature adjusting chamber, and further provided are: a connection destination switching valve that connects one reaction vessel through which the sample flows out of the catalyst layer and another reaction vessel selected from the reaction vessels other than the one reaction vessel among the plurality of reaction vessels; and a selection valve that selects an outflow destination of the sample from the one reaction vessel, between the sample flow path and the another reaction vessel via the connection destination switching valve, in which the control unit is configured to conduct a control to perform a selection of the outflow destination of the sample with the selection valve, perform the switching control with the outflow side switching valve such that the one reaction vessel works as the outflow source reaction vessel when connection to the sample flow path is selected by the selection, and perform the switching control with the outflow side switching valve such that the another reaction vessel works as the outflow source reaction vessel when connection to the another reaction vessel is selected by the selection.
(d) The control unit performs the switching control to a next one of the feed destination reaction vessel and a next one of the outflow source reaction vessel, after a preset settling time has elapsed since a feed of the sample from the feed flow path to the feed destination reaction vessel is started and the sample flowing out of the outflow source reaction vessel via the sample flow path has been collected.
(e) The control unit performs the switching control to a next one of the feed destination reaction vessel and a next one of the outflow source reaction vessel, after the sample flowing out of the outflow source reaction vessel via the sample flow path has been collected at each sampling period determined based on a preset rule since a feed of the sample from the feed flow path to the feed destination reaction vessel is started and a concentration change index of a focused component contained in the sample has become equal to or less than a preset threshold based on a result of concentration analysis performed on the focused component.
(f) The control unit performs the switching control to a next one of the feed destination reaction vessel and a next one of the outflow source reaction vessel, after a feed of the sample from the sample feeder is stopped.

### Advantageous Effects of Invention

The present invention performs switching control of a feed side switching valve and an outflow side switching valve such that a reaction rate test is performed using a plurality of reaction vessels including a catalyst layer, under at least three conditions having different residence times in the catalyst layer. As a result, the reaction rate test intended to measure a reaction rate of a chemical reaction that proceeds in the presence of a catalyst can be conducted without manually replacing the reaction vessel.

### BRIEF DESCRIPTION OF DRAWINGS

FIG. 1 is a schematic diagram illustrating a reaction of feeding a raw material to a catalyst layer to obtain a product.

FIG. 2 is a schematic diagram illustrating how a reaction rate curve changes according to variations in reaction systems.

FIG. 3 is an explanatory diagram of a procedure for finding a reaction rate curve.

FIG. 4 is a configuration diagram of a conventional test device.

FIG. 5 is a configuration diagram of a test device according to a first embodiment.

FIG. 6 is an example of an operation flow of the test device according to the first embodiment.

FIG. 7 is a flowchart related to an operation of verifying switching of a column.

FIG. 8 is a configuration diagram of a test device according to a second embodiment.

FIG. 9 is a configuration diagram of a test device according to a third embodiment.

### DESCRIPTION OF EMBODIMENTS

First, the reason why it is necessary to determine the reaction rate in designing a reactor including a catalyst layer filled with a solid catalyst, and disadvantages of a conventional test device will be described.

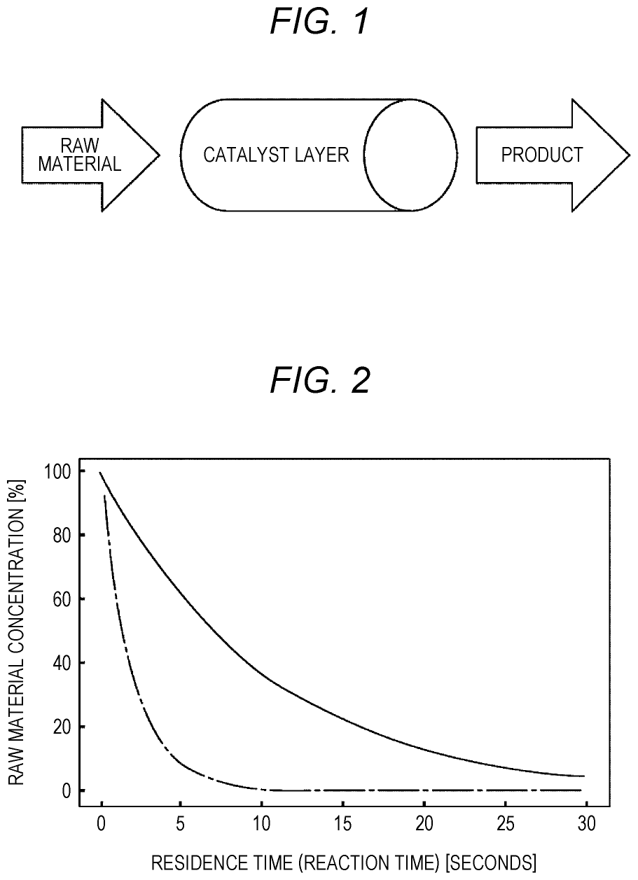

As illustrated in FIG. 1, in a reaction system using a catalyst layer, a raw material fluid is flown through the catalyst layer, and the raw material and the catalyst are brought into contact with each other to cause a catalytic reaction to proceed, thereby obtaining a target component from among products generated by the reaction. In general, under the condition that the reaction temperature and the concentration of the raw material in the fluid are fixed, as the residence time in the catalyst layer is longer, more raw material is consumed by the reaction, and a product in an amount corresponding to the consumption amount of the raw material is obtained.

At this time, the relationship (reaction rate curve) between the residence time of the raw material in the catalyst layer, that is, the reaction time (for example, in “seconds”) and the raw material concentration at the outlet of the catalyst layer (the percentage display value of the outlet concentration to the inlet concentration to the catalyst layer) can be illustrated as in FIG. 2. In a reaction system having a high reaction rate, the raw material concentration rapidly decreases with a short residence time as indicated by the dashed-dotted line. On the other hand, in a reaction system having a low reaction rate, as indicated by the solid line, the decrease in the raw material concentration attributable to the increase in the residence time is moderate, as compared with the reaction system having a high reaction rate.

Such variations in reaction rate affect the design of a reactor intended to obtain a target component from the raw material. For example, in a reaction system (reaction rate: high) in which a predetermined amount of raw material can be converted into a product in a short reaction time (residence time), the volume of the catalyst layer can be made smaller, that is, the capacity of the reaction tower can be made smaller. On the other hand, in a reaction system (reaction rate: low) in which a longer reaction time (residence time) is necessary to convert a predetermined amount of raw material into a product, it is required to make the capacity of the reaction tower, that is, the volume of the catalyst layer larger.

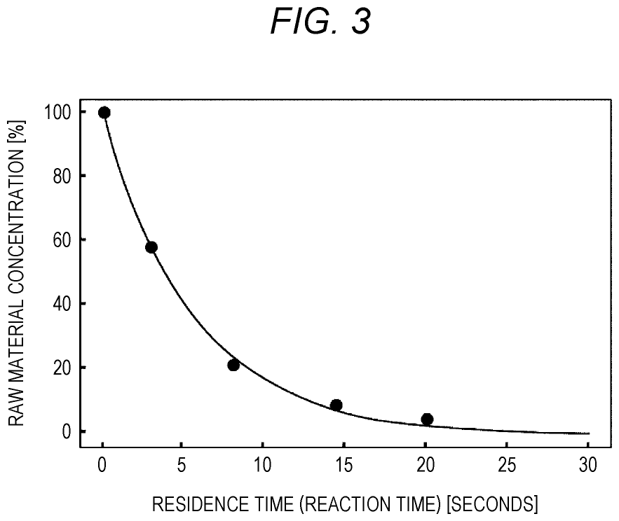

In this manner, the reaction rate of the catalytic reaction is one of important catalyst characteristics supposed to be grasped in advance in designing a reactor. Thus, in order to determine the reaction rate of a certain reaction system, a reaction rate test is conducted in which the raw material concentration at the outlet of the catalyst layer is measured while changing the residence time during which the raw material passes through the catalyst layer. Then, as illustrated in FIG. 3, the reaction rate curve is found by fitting a curve to the result of plotting a plurality of points of the correspondence relationship of the raw material concentration at the outlet of the catalyst layer with respect to the residence time.

Here, as a procedure for changing the residence time of the raw material in the catalyst layer, it is also conceivable to sequentially change the feed flow rate of the raw material to the catalyst layer filled with a predetermined amount of catalyst. However, with such a procedure, the fluidized state of the raw material flowing through the catalyst layer may sometimes greatly differ depending on the change in the feed flow rate. As a result, it is difficult to conduct the reaction rate test while conditions other than the residence time are in a matched state, and a precise reaction rate curve may be unlikely to be obtained.

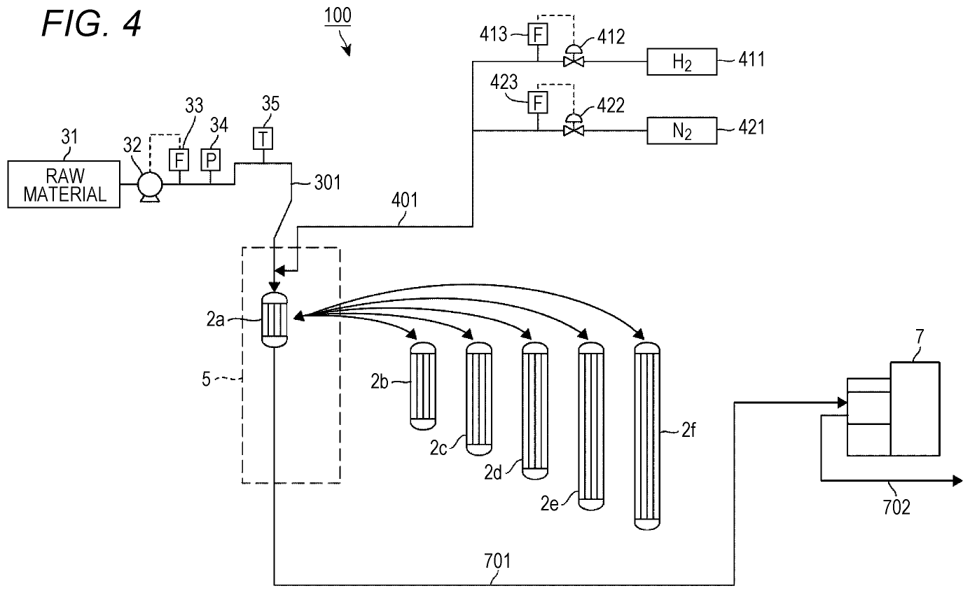

Thus, conventionally, a reaction rate test has been conducted using a test device 100 having the configuration exemplified in FIG. 4 to find a reaction rate curve. The test device 100 illustrated in FIG. 4 is configured as a device that performs a reaction experiment intended to obtain a reaction rate curve of a hydrogenation reaction for hydrogenating a raw material contained in a raw material fluid, for example.

To briefly describe the configuration of the test device 100, a raw material fluid (for example, a liquid) containing a raw material is accumulated in a raw material feeder 31. This raw material fluid is fed via a raw material feed line 301 at a preset flow rate by a pump 32, based on a flow rate measurement result by a flowmeter 33. The raw material feed line 301 is provided with a pressure gauge 34 and a thermometer 35 and can measure the feed pressure and the feed temperature of the raw material fluid. The raw material feeder 31, the pump 32, and the flowmeter 33 constitute a sample feeder that feeds a raw material fluid as a sample at a preset flow rate, and the raw material feed line 301 constitutes a sample feed path.

Meanwhile, a hydrogen gas for use in hydrogenation reaction is accumulated in a hydrogen gas feeder 411. The hydrogen gas is fed at a preset flow rate while the flow rate is adjusted by a flow rate adjusting valve 412, based on a flow rate measurement result by a flowmeter 413. In addition, a nitrogen gas for use in adjusting the concentration of the hydrogen gas is accumulated in a nitrogen gas feeder 421. The nitrogen gas is fed at a preset flow rate while the flow rate is adjusted by a flow rate adjusting valve 422, based on a flow rate measurement result by a flowmeter 423.

These hydrogen gas and nitrogen gas are joined and then fed as a mixed gas (hereinafter, also referred to as a “reaction gas”) via a reaction gas feed line 401. A downstream end portion of the reaction gas feed line 401 joins the raw material feed line 301 that feeds the raw material fluid. The hydrogen gas feeder 411, the flow rate adjusting valve 412, and the flowmeter 413, and the nitrogen gas feeder 421, the flow rate adjusting valve 422, and the flowmeter 423 constitute a sample feeder that feeds the hydrogen gas or nitrogen gas as a sample at a preset flow rate, and the reaction gas feed line 401 constitutes a sample feed path.

The catalyst used in the hydrogenation reaction of the raw material is filled in each of a plurality of catalyst columns 2a to 2f that are reaction vessels. These catalyst columns 2a to 2f are constituted by, for example, stainless steel cylindrical vessels having a diameter of 5 mm. The cylindrical vessels constituting the catalyst columns 2a to 2f are configured such that its length dimensions are different from each other in a range of, for example, 50 to 300 mm and are filled with the catalyst with different volumes according to its own length dimensions. In this example, a catalyst layer filled with a larger volume of catalyst is provided for a catalyst column having a larger length dimension among the catalyst columns 2a to 2f. Note that the above-described constituent materials and dimensions, and the number of catalyst columns 2a to 2f to be used are examples and may be appropriately modified.

In the test device 100 of this example, the plurality of catalyst columns 2a to 2f having different volumes of the catalyst layer are prepared in advance, and one (the catalyst column 2a in the example illustrated in FIG. 4) selected from among these catalyst columns 2a to 2f is disposed inside an oven 5. The oven 5 heats the internal temperature to a preset temperature (for example, 100° C.).

The oven 5 also can modify the set temperature in a range of 40 to 150° C., for example. The temperature dependence of the reaction rate can also be evaluated by conducting the reaction rate test under each of different conditions of the set temperature. From this viewpoint, the oven 5 plays a role of a temperature adjusting mechanism (temperature adjusting chamber) that adjusts the temperature of the catalyst columns 2a to 2f, that is, the catalyst layer accommodated inside the oven 5.

A downstream end portion of the raw material feed line 301 is connected to an inlet side of the catalyst column 2a accommodated inside the oven 5. This downstream end portion is located on a downstream side of the joint position with the reaction gas feed line 401 described above. Meanwhile, a sampling line (sample flow path) 701 intended to collect a sample for analysis that has passed through the catalyst layer inside the catalyst column 2a is connected to an outlet side of the catalyst column 2a.

A downstream end of the sampling line 701 is connected to an analyzer 7 provided outside the test device 100. In a case where the sample flowing out of the sampling line 701 is a liquid, a case where liquid chromatography (LC) is used as the analyzer 7 that performs composition analysis and quantitative analysis of the sample can be exemplified. Here, in feeding the sample as a liquid, a sample collection mechanism using, for example, a syringe may be provided inside the analyzer 7 in some cases. In these cases, if the sample contains bubbles or dissolved gas, a difficulty may be likely to occur at the time of sample collection by the sample collection mechanism. Thus, a gas-liquid separator or a degasser may be installed between the downstream end of the sampling line 701 and the analyzer 7, as necessary.

The sample after the product is analyzed by the analyzer 7 is discharged via a discharge line 702.

Note that the analyzer 7 connected to the sampling line 701 is not limited to the LC, and gas chromatography (GC) may be used when the sample is a gas. Furthermore, depending on the contents of the analysis, another analyzer provided also with mass spectrometry (MS), such as LC-MS or GC-MS, may be used. In addition, when the sample is a liquid, a fraction collector may be provided on an inlet side of the analyzer 7, and the sampling line 701 may be connected to the provided fraction collector.

In the test device 100 having the above-described configuration, the catalyst column 2a to be used in the current reaction rate test is selected from the plurality of prepared catalyst columns 2a to 2f and disposed inside the oven 5, and the raw material feed line 301 and the sampling line 701 are attached to the catalyst column 2a. Thereafter, the temperature inside the oven 5 is raised, and once the temperature is stabilized at the set temperature, a feed of samples such as the raw material fluid and the reaction gas is started.

Since the settling of the reaction requires, for example, about one hour, sampling and analysis of the sample is conducted by the analyzer 7 after the settling time has elapsed from the start of the feed of the samples. In a case where the temperature dependence of the reaction rate is also evaluated, the feed of the samples is stopped, and the set temperature of the oven 5 is modified. Then, when the temperature inside the oven 5 is stabilized at the new set temperature, the operation of “feed of samples→waiting for settling→sampling and analysis of samples” described above is repeated. Note that the feed of the samples is not necessarily stopped when the set temperature of the oven 5 is modified. For example, the feed of the raw material and the hydrogen gas may be stopped and only the feed of the nitrogen gas may be continued, or when there is a sufficient amount of the raw material and the hydrogen gas, the feed of the raw material and the hydrogen gas may be continued.

When the above operation is completed for all the set temperatures necessary for the evaluation of the temperature dependence in this manner, the feed of the samples (the raw material fluid and the reaction gas) and the heating of the oven 5 are stopped. Thereafter, when the temperature inside the oven 5 decreases to a temperature at which the work can be conducted, the catalyst column 2a is removed, the next catalyst column 2b is attached, and then the reaction rate test is repeated in the manner described above.

Here, as illustrated in FIG. 2, in order to obtain a reaction rate curve as a curve, it is necessary to perform a reaction rate test with at least three residence times (reaction times) different from each other. Then, in order to obtain a more accurate reaction rate curve, it may be sometimes necessary to perform a reaction rate test with four or more residence times different from each other.

Therefore, in the test device 100 having the conventional configuration illustrated in FIG. 4, it is necessary to conduct the above-described reaction rate test and replacement work on the catalyst columns 2a to 2f corresponding to three or more residence times. However, the waiting time is frequently caused, and the replacement work for the catalyst columns 2a to 2f that repeatedly occur has been a large burden on the test conductor.

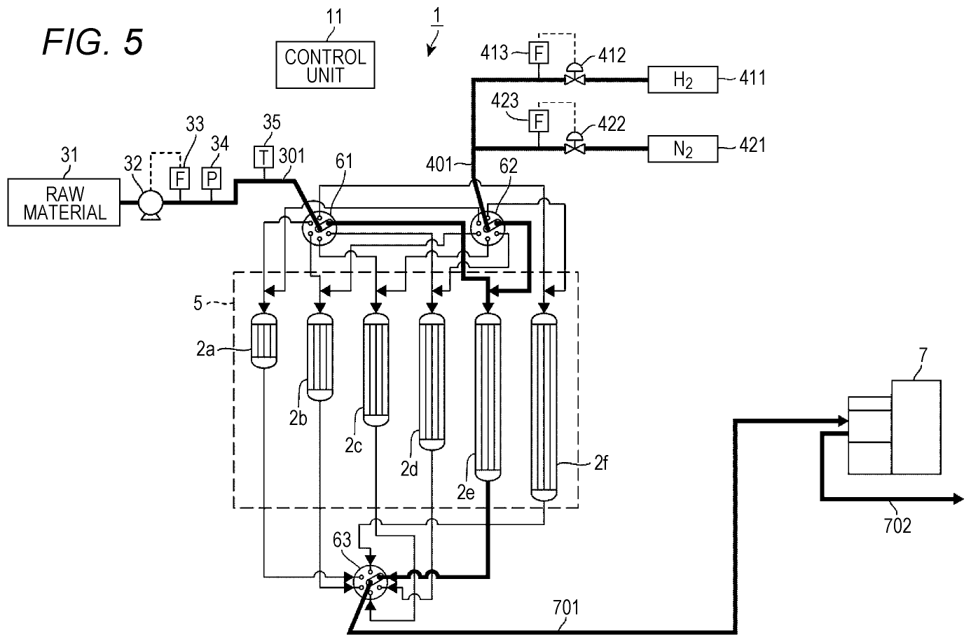

Thus, a test device 1 of the present embodiment has a configuration that enables to automatically conduct a reaction rate test intended to obtain a reaction rate curve by quitting the replacement work for the catalyst columns 2a to 2f described above. Hereinafter, the configuration and action of the test device 1 according to the present embodiment will be described with reference to FIGS. 5 to 7.

Note that, in each of test devices 1, 1a, and 1b illustrated in FIGS. 5, 8, and 9, the same constituent elements as those of the test device 100 described with reference to FIG. 1 will be denoted by the same reference signs as those used in FIG. 1.

In the test device 1 illustrated in FIG. 5, at least three (six in the example in the drawing) catalyst columns 2a to 2f having different volumes of the catalyst layer from each other are attached in advance inside a common oven 5. In this manner, the test device 1 of the present embodiment has a configuration in which the replacement work for the catalyst columns 2a to 2f does not occur.

Meanwhile, when the plurality of catalyst columns 2a to 2f is accommodated inside the oven 5, it is required to select the catalyst columns 2a to 2f as the feed destinations of the samples from a raw material feed line 301 and a reaction gas feed line 401 and the catalyst columns 2a to 2f as the outflow sources of the samples to a sampling line 701.

From this viewpoint, the test device 1 of the present embodiment is provided with a feed side switching valves 61 and 62 and an outflow side switching valve 63. The feed side switching valves 61 and 62 play a role of connecting each of the raw material feed line 301 for the raw material fluid and the reaction gas feed line 401 for the reaction gas, which are the samples, to the feed destination selected from the plurality of catalyst columns 2a to 2f. In addition, the outflow side switching valve 63 plays a role of connecting the sample flow path to the outflow source catalyst columns 2a to 2f through which the sample flows out of the catalyst layer.

These feed side switching valves 61 and 62 and the outflow side switching valve 63 are subjected to switching control conducted by a control unit 11. The control unit 11 executes switching of the catalyst columns 2a to 2f as the feed destination and the outflow source of the samples, using these feed side switching valves 61 and 62 and outflow side switching valve 63. For example, the control unit 11 is constituted by a computer, a control circuit, or the like. In particular, in the test device 1 of the present embodiment, the control unit 11 performs switching control of the feed side switching valves 61 and 62 and the outflow side switching valve 63 such that the feed destination and the outflow source of the samples coincide with each other among the catalyst columns 2a to 2f.

For example, FIG. 5 illustrates a state in which the feed side switching valves 61 and 62 and the outflow side switching valve 63 are switched such that the raw material feed line 301, the reaction gas feed line 401, and the sampling line 701 are connected to the catalyst column 2e. Then, by sequentially conducting this switching, the reaction rate test can be performed under at least three (up to six in the example illustrated in FIG. 5) conditions having different residence times.

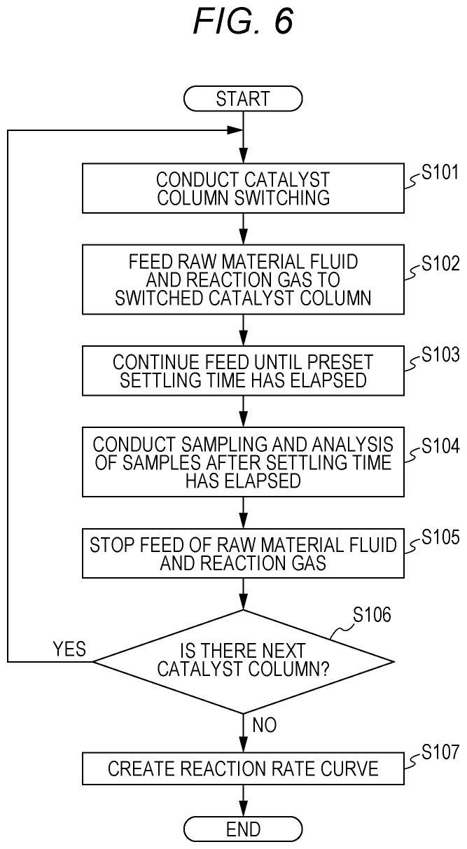

Next, an operation of the test device 1 having the above-described configuration will be described also with reference to FIG. 6 in addition to FIG. 5. In conducting the reaction rate test using the test device 1 (start), the catalyst column 2e to be tested is selected from the catalyst columns 2a to 2f accommodated in the oven 5, and the feed side switching valves 61 and 62 and the outflow side switching valve 63 are switched (step S101). Subsequently, a feed of the raw material fluid and the reaction gas as samples to the switched catalyst column 2e is conducted (step S102).

After that, the feed of the samples is continued until a preset settling time has elapsed (step S103). During this period of time, the samples may be discharged through a discharge line 702 via the sampling line 701. After the settling time has elapsed, sampling and analysis of the samples are conducted via the sampling line 701 (step S104). Thereafter, the feed of the raw material fluid and the reaction gas to the catalyst column 2e is stopped (step S105).

Note that, in a case where the temperature dependence of the reaction rate described using the conventional test device 100 in FIG. 4 is also evaluated here, the operations in steps S102 to S104 are repeated after the set temperature of the oven 5 is modified. However, in this case, in step S102, the operation of feeding the raw material fluid and the reaction gas will be conducted on the catalyst column 2e after the set temperature is modified.

After the sample feed stop operation in step S105, it is confirmed whether any of the catalyst columns 2a to 2d and 2f on which the reaction rate test is supposed to be conducted next is set (step S106). For example, it is assumed that the reaction rate test has already been completed for the catalyst columns 2a to 2d at the timing when the reaction rate test for the catalyst column 2e is finished, and the reaction rate test is to be conducted on the remaining catalyst column 2f (step S106: YES). In this case, switching to the catalyst column 2f is conducted in step S101, and the operations in steps S102 to S106 are repeated.

Thereafter, in a case where there are no catalyst columns 2a to 2f to be switched to and on which the reaction rate test is supposed to be conducted next (step S106: NO), the reaction rate test is terminated. Then, for example, fitting of the curve is performed by an external computer that has acquired the test result from an analyzer 7, a reaction rate curve is automatically created, and the operation is finished (end).

The test device 1 according to the present embodiment has the following effects. Switching control of the feed side switching valves 61 and 62 and the outflow side switching valve 63 is performed such that a reaction rate test is performed using the plurality of catalyst columns 2a to 2f including the catalyst layer, under at least three conditions having different residence times in the catalyst layer. As a result, the reaction rate test intended to determine a reaction rate of a chemical reaction that proceeds in the presence of a catalyst can be conducted without manually performing replacement work for the catalyst columns 2a to 2f.

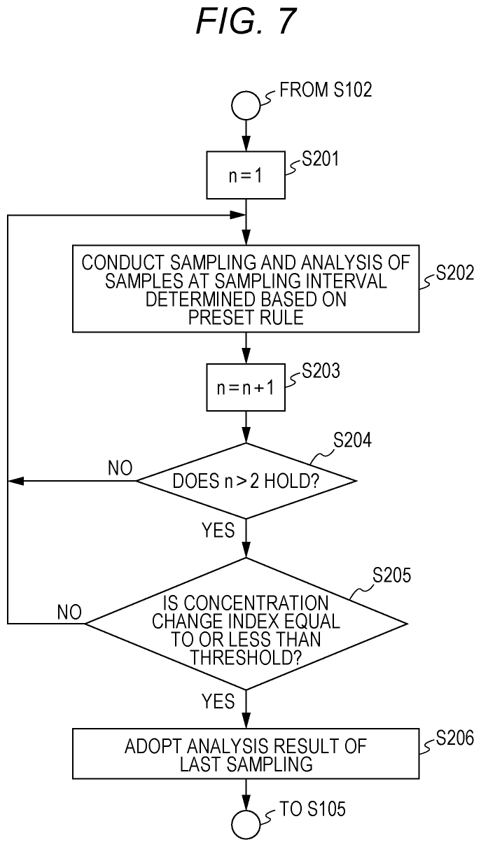

Here, in step S103 described with reference to FIG. 6, the lapse of the actual settling time may be confirmed instead of the procedure of waiting for the lapse of the preset settling time. FIG. 7 illustrates an example of the operation conducted instead of step S103 in this case.

After starting the feed of the samples in step S102 in FIG. 6, the control unit 11 starts counting the number of times of conducted sampling (n=1) (step S201). Then, after a sampling interval determined based on a sampling rule programmed in advance has elapsed, a first sampling of the samples having passed through the catalyst layer is performed, and analysis is conducted by the analyzer 7 (step S202).

Here, regarding the sampling rule, a case where various rules are freely set to the control unit 11 can be expected. However, in order to efficiently grasp the lapse of the actual settling time, it is preferable to set the sampling period such that “the settling time (for example, one hour) in step S103 in FIG. 6>the sampling period” holds.

As a specific example, a rule may be set in which the sampling period after the count of the number of times of conducted sampling in step S201 is started is set to 30 minutes, and the subsequent sampling period is assigned as every 10 minutes.

In addition, a rule may be set in which the first sampling period is set to zero minutes, sampling is conducted immediately after the count of the number of times of conducted sampling is started, and the subsequent sampling period is assigned as every five minutes.

Besides, the first sampling period is set to zero minutes. Then, for the subsequent sampling period, a table in which the concentration change of the focused component obtained from the analysis result by the analyzer 7 is associated with the sampling period may be previously created, and the sampling period may be changed based on this table. In the table, it is possible to exemplify a case where the sampling period is set longer as the focused component for which whether to have been settled is to be verified has a larger concentration change, and the sampling period is set shorter as the concentration change of the focused component becomes smaller and near settled.

When the first sampling and analysis have been conducted in this manner, the number of times of conducted sampling is incremented (step S203), and it is confirmed whether the incremented value exceeds two (step S204). In a case where the value does not exceed two (step S204: NO), the operations in steps S202 to S203 are repeated to conduct the second sampling and analysis.

In a case where the incremented value exceeds two (step S204: NO), since the sampling and analysis have been conducted at least twice, the previous analysis result and the current analysis result can be compared. Thus, it is checked, from the previous and current concentration analysis results for the focused component for which whether the reaction system has been settled is to be verified, whether the concentration change index of the focused component is equal to or less than a preset threshold (step S205).

For example, in a case where it is verified that the actual settling time has elapsed because the concentration of the target component in the product contained in the sample is stabilized, this target component is selected as the focused component. In addition, in a case where it is verified that the settling time has elapsed because the concentration of a by-product in the product is stable in a sufficiently decreased state, the above by-product is selected as the focused component.

Moreover, the concentration change index may be an absolute value of the concentration difference of the focused component between the previous time and the current time, or may be a ratio of the current concentration with reference to the concentration at the previous analysis. The concentration change index may also be a change rate indicating the ratio of the absolute value of the concentration difference of the focused component between the previous time and the current time with respect to the concentration at the time of the previous analysis that is assigned as a reference.

In a case where the concentration change index of the focused component is not equal to or less than the preset threshold (step S205: NO), the operations in steps S202 to S204 are repeated. On the other hand, in a case where the concentration change index is equal to or less than the threshold (step S205: YES), it is verified that the actual settling time has elapsed, and the analysis result of the last sampling is adopted as the analysis result of the reaction rate test (step S206). Thereafter, the process returns to step S105 in FIG. 6, the feed of the raw material fluid and the reaction gas is stopped, and the necessity of switching the catalyst columns 2a to 2f is verified (step S106).

According to the operation described with reference to FIG. 7, the lapse of the actual settling time can be actively grasped, and unnecessary waiting time can be reduced.

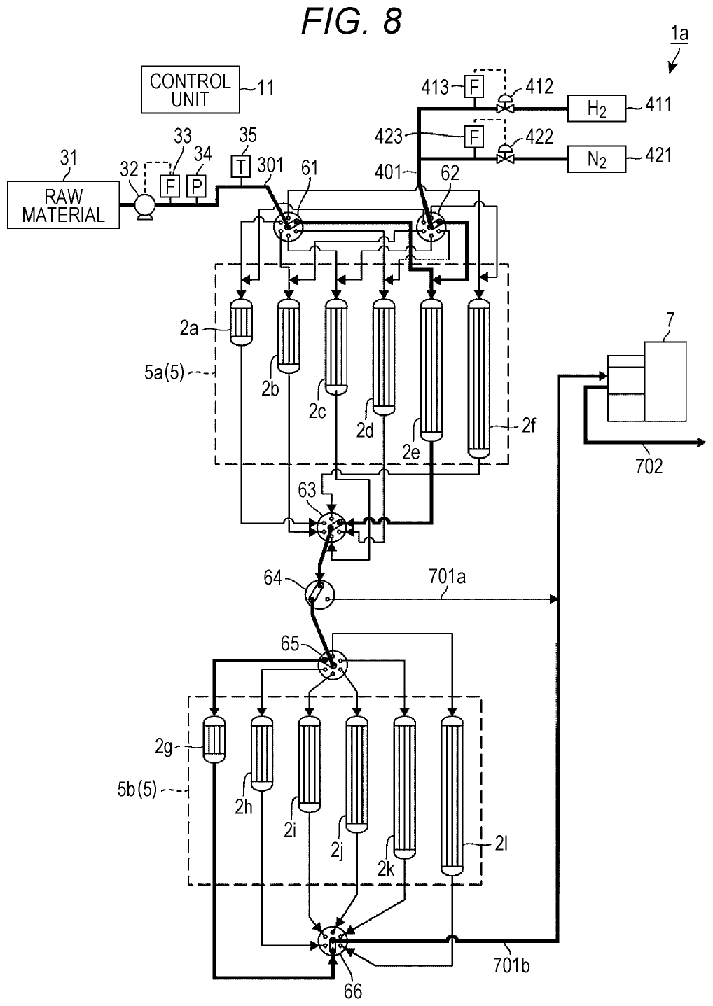

Subsequently, an exemplary configuration of the test device la according to a second embodiment will be described with reference to FIG. 8. The test device la according to the second embodiment has a configuration in which a plurality of ovens 5, for example, two ovens 5 (an upstream side oven 5a and a downstream side oven 5b) are coupled in series. The upstream side oven 5a accommodates a plurality of catalyst columns 2a to 2f having different volumes of the catalyst layer from each other, and similarly, the downstream side oven 5b also accommodates a plurality of catalyst columns 2g to 2l.

Then, an intermediate switching valve 65 is provided in a flow path linking the upstream side oven 5a and the downstream side oven 5b. The intermediate switching valve 65 plays a role of connecting the upstream side catalyst columns 2a to 2f that are accommodated in the upstream side oven 5a and through which the sample flows out of the catalyst layer, and the downstream side catalyst columns 2g to 2l accommodated in the downstream side oven 5b. Then, in addition to the switching control of the catalyst columns 2a to 2f by the feed side switching valves 61 and 62 and the outflow side switching valve 63 described with reference to FIG. 5, a control unit 11 performs connection control between the upstream side catalyst columns 2a to 2f and the downstream side catalyst columns 2g to 2l with the intermediate switching valve 65.

Note that a selection valve 64 provided on an upstream side of the intermediate switching valve 65 plays a role of switching between a case where the upstream side oven 5a is used alone and a case where the upstream side oven 5a and the downstream side oven 5b are coupled in series and used. In a case where the upstream side oven 5a is used alone, the configuration is similar to that of the example used in FIG. 5, in which a reaction rate test is conducted using any one of the catalyst columns 2a to 2f alone, and the sample flowing out of the catalyst layer is sent to an analyzer 7 via a sampling line 701a.

On the other hand, in a case where the upstream side oven 5a and the downstream side oven 5b are coupled in series and used, the total volume of the catalyst layer has the sum value of the volume of the catalyst layer of any one of the catalyst columns 2a to 2f accommodated in the upstream side oven 5a and the volume of the catalyst layer of any one of the catalyst columns 2g to 2l accommodated in the downstream side oven 5b. As a result, in the example illustrated in FIG. 8, the reaction rate test can be conducted with 36 different patterns of residence times set by combining the six catalyst columns 2a to 2f and the six catalyst columns 2g to 2l. An outlet side of the catalyst columns 2g to 2l is connected to a sampling line 701b by an outflow side switching valve 66, and the sample flowing out of the catalyst layer is sent to the analyzer 7 via the sampling line 701b.

Summarizing the above usage, 42 different patterns of residence times together with the case of using the upstream side oven 5a alone can also be set in the test device la illustrated in FIG. 8 as a whole. It is not essentially required to provide the selection valve 64 and the sampling line 701a, and the upstream side oven 5a and the downstream side oven 5b may be regularly used in a coupled state in series. At this time, if the upstream side oven 5a and the downstream side oven 5b are provided with at least two catalyst columns 2a and 2b and at least two catalyst columns 2g and 2h, respectively, the reaction rate test can be conducted by setting four different patterns of residence times. This satisfies at least three conditions with different residence times, and a reaction rate curve can be specified.

Furthermore, the number of ovens 5 coupled in series is not restricted to two and may be three or more. In this case, focusing on the two ovens 5 connected to each other via the intermediate switching valve 65, the upstream side oven 5a and the downstream side oven 5b are specified. In addition, if the selection valve 64 and the sampling line 701a are provided on an upstream side of each intermediate switching valve 65, at least three conditions having different residence times can be set and the reaction rate test can be conducted by providing one catalyst column 2a in each of three ovens 5 at the minimum. At this time, it is not essential for these three catalyst columns 2a to have different volumes of the catalyst layer, and the volumes of the catalyst layer may be the same as each other.

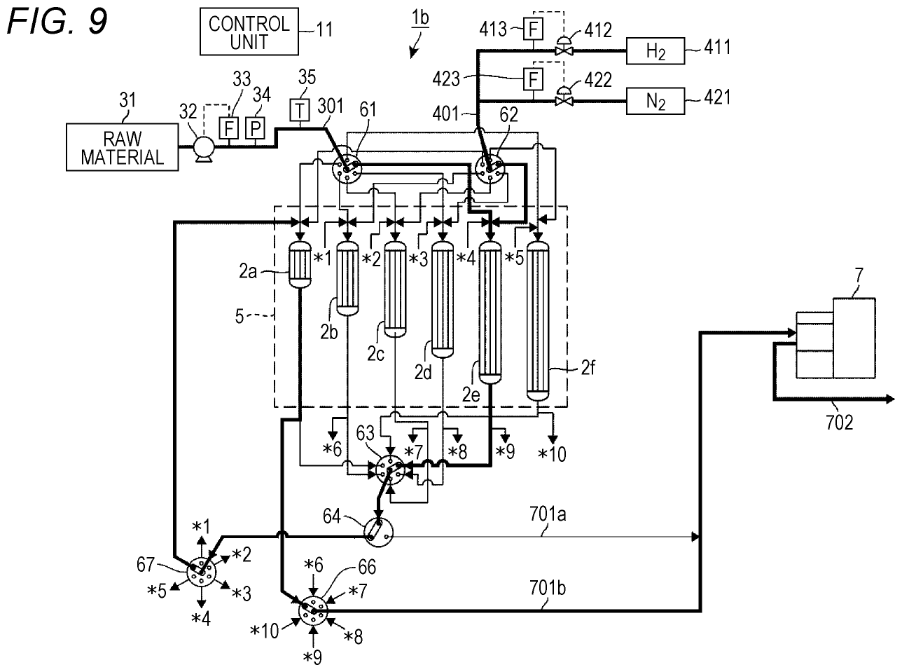

Next, an exemplary configuration of the test device 1b according to a third embodiment will be described with reference to FIG. 9. In the test device 1b according to the third embodiment, a plurality of catalyst columns 2a to 2f having different volumes of the catalyst layer from each other is provided inside a common oven 5, and two catalyst columns selected from the catalyst columns 2a to 2f can be connected in series.

From this viewpoint, the test device 1b has a configuration including a selection valve 64 and a connection destination switching valve 67 in addition to the configuration of the test device 1 described with reference to FIG. 5. The connection destination switching valve 67 plays a role of connecting one of the catalyst columns 2a to 2f (the catalyst column 2e in the example in FIG. 9) through which the sample flows out of the catalyst layer and another one of the catalyst columns 2b to 2f and 2a (the catalyst column 2a in the example in FIG. 9) selected from the catalyst columns other than the one catalyst column 2e. In addition, the selection valve 64 plays a role of selecting an outflow destination of the sample from the one of the catalyst columns 2a to 2f, between a sampling line 701a and the another one of the catalyst columns 2b to 2f and 2a connected via the connection destination switching valve 67.

The test device 1b also includes a first-stage outflow side switching valve 63 provided on an upstream side of the selection valve 64, and a second-stage outflow side switching valve 66 provided on a most downstream side of the one of the catalyst columns 2a to 2f and the another one of the catalyst columns 2b to 2f and 2a connected to each other. The second-stage outflow side switching valve 66 plays a role of connecting the another one of the catalyst columns 2b to 2f and 2a to a sampling line 701b.

In the test device 1b having the above-described configuration, a control unit 11 conducts control to select the outflow destination of the sample with the selection valve 64. In a case where connection to the sampling line 701a is selected by this selection, switching control to the sampling line 701a via the outflow side switching valve 63 is performed such that the one of the catalyst columns 2a to 2f works as an outflow source. In addition, in a case where connection to the another one to 2f and 2a is selected by the selection valve 64, switching control to the sampling line 701b via the outflow side switching valve 66 is performed such that the another one to 2f and 2a works as an outflow source.

In the test device 1b illustrated in FIG. 9, if two catalyst columns 2a and 2b are provided inside the oven 5 at the minimum, the reaction rate test can be conducted by setting at least three conditions having different residence times between a case where each of the catalyst columns 2a and 2b is used alone and a case where the catalyst columns 2a and 2b are connected in series.

In addition, the test device 1b may also have a configuration in which three or more stages of the catalyst columns 2a to 2f can be connected in series. In this case, a plurality of sets of the selection valve 64, the connection destination switching valve 67, the outflow side switching valve 66, and the sampling line 701b only needs to be provided in stages. In the configuration in which the catalyst columns 2a to 2f can be connected in series in three or more stages, even if the catalyst columns 2a to 2f have the same volume of the catalyst layer as each other, the reaction rate test can be conducted by setting at least three conditions having different residence times.

As described above, the operation flows described with reference to FIGS. 6 and 7 can also be applied to the test devices 1a and 1b according to the second and third embodiments described with reference to FIGS. 8 and 9.

In addition, in the test devices 1, 1a, and 1b according to the first to third embodiments, the procedure of changing the volume of the catalyst layer is not limited to a case where the catalyst columns 2a to 2f have different length dimensions. For example, the volume of the catalyst layer may be changed by making the diameters of the catalyst columns 2a to 2f different.

In addition, the type of the reaction conducted using the catalyst is not limited to the example intended for the hydrogenation reaction and may be other reactions such as an oxidation reaction, a reduction reaction, and a thermal decomposition reaction. Then, according to the contents of the reaction, only one system of the test feeder may be provided, or three or more systems of the test feeders may be provided. In addition, a preheater may be installed in the sample feeder as necessary, and the preheated sample may be fed to the catalyst columns 2a to 2f.

An exemplary configuration of the temperature adjusting chamber that accommodates the plurality of catalyst columns 2a to 2f and adjusts the temperature is not restricted to the oven 5 and may be an aluminum block heater, a thermostatic box, a test refrigerator, or the like. In addition, the temperature adjusting mechanism is not restricted to a temperature adjusting chamber of a type that accommodates the plurality of catalyst columns 2a to 2f and also includes a configuration in which individual catalyst columns 2a to 2f are covered with a jacket heater, a tape heater, or the like.

### REFERENCE SIGNS LIST

1, 1a, 1b, 100 Test device
11 Control unit
2a to 2f Catalyst column
301 Raw material feed line
31 Raw material feeder
32 Pump
33 Flowmeter
34 Pressure gauge
35 Thermometer
401 Reaction gas feed line
411 Hydrogen gas feeder
412 Flow rate adjusting valve
413 Flowmeter
421 Nitrogen gas feeder
422 Flow rate adjusting valve
423 Flowmeter
5 Oven
5a Upstream side oven
5b Downstream side oven
61 Feed side switching valve
62 Feed side switching valve
63 Outflow side switching valve
64 Selection valve
65 Intermediate switching valve
66 Outflow side switching valve
67 Connection destination switching valve
701, 701a, 701b Sampling line
702 Discharge line
7 Analyzer

1. A test device that performs a reaction rate test of a chemical reaction that proceeds in a presence of a catalyst, the test device comprising:
a sample feeder that feeds a sample to be fed to the catalyst at a preset flow rate;
a plurality of reaction vessels each including a catalyst layer filled with the catalyst;
a temperature adjusting mechanism that adjusts a temperature of the reaction vessels;
a feed side switching valve that connects a feed flow path through which the sample is fed from the sample feeder, to a feed destination reaction vessel selected from the plurality of reaction vessels;
an outflow side switching valve that connects a sample flow path intended to collect the sample for analysis that has passed through the catalyst layer, to an outflow source reaction vessel from which the sample flows out of the catalyst layer; and
a control unit that performs switching control of the feed destination and outflow source reaction vessels with the feed side switching valve and the outflow side switching valve, such that the reaction rate test is performed under at least three conditions having different residence times in the catalyst layer.

2. The test device according to claim 1, wherein
at least three reaction vessels having different volumes of the catalyst layer from each other are provided,
wherein the control unit performs the switching control such that the feed destination reaction vessel and the outflow source reaction vessel coincide with each other.

3. The test device according to claim 1, wherein
the temperature adjusting mechanism is configured to adjust the temperature while the reaction vessels are in an accommodated state inside a temperature adjusting chamber,
the test device further comprising:
an upstream side temperature adjusting chamber and a downstream side temperature adjusting chamber each accommodating a plurality of the reaction vessels having different volumes of the catalyst layer from each other; and
an intermediate switching valve that connects an upstream side reaction vessel that is accommodated in the upstream side temperature adjusting chamber and through which the sample flows out of the catalyst layer, and a downstream side reaction vessel that is selected from the plurality of the reaction vessels accommodated in the downstream side temperature adjusting chamber and to which the sample flowing out of the upstream side reaction vessel is fed, and
the control unit performing a connection control between the upstream side reaction vessel and the downstream side reaction vessel with the intermediate switching valve, in addition to the switching control of the reaction vessels.

4. The test device according to claim 1, wherein
the temperature adjusting mechanism is configured to adjust the temperature while a plurality of the reaction vessels having different volumes of the catalyst layer from each other is in an accommodated state inside a temperature adjusting chamber,
the test device further comprising:
a connection destination switching valve that connects one reaction vessel through which the sample flows out of the catalyst layer and another reaction vessel selected from the reaction vessels other than the one reaction vessel among the plurality of reaction vessels; and
a selection valve that selects an outflow destination of the sample from the one reaction vessel, between the sample flow path and the another reaction vessel via the connection destination switching valve, and
the control unit is configured to:
conduct a control to perform a selection of the outflow destination of the sample with the selection valve;
perform the switching control with the outflow side switching valve, such that the one reaction vessel works as the outflow source reaction vessel when connection to the sample flow path is selected by the selection; and
perform the switching control with the outflow side switching valve, such that the another reaction vessel works as the outflow source reaction vessel when connection to the another reaction vessel is selected by the selection.

5. The test device according to claim 1, wherein
the control unit performs the switching control to a next one of the feed destination reaction vessel and a next one of the outflow source reaction vessel, after a preset settling time has elapsed since a feed of the sample from the feed flow path to the feed destination reaction vessel is started and the sample flowing out of the outflow source reaction vessel via the sample flow path has been collected.

6. The test device according to claim 1, wherein
the control unit performs the switching control to a next one of the feed destination reaction vessel and a next one of the outflow source reaction vessel, after the sample flowing out of the outflow source reaction vessel via the sample flow path has been collected at each sampling period determined based on a preset rule since a feed of the sample from the feed flow path to the feed destination reaction vessel is started and a concentration change index of a focused component contained in the sample has become equal to or less than a preset threshold based on a result of concentration analysis performed on the focused component.

7. The test device according to claim 1, wherein
the control unit performs the switching control to a next one of the feed destination reaction vessel and a next one of the outflow source reaction vessel, after a feed of the sample from the sample feeder is stopped.

8. A test method for performing a reaction rate test of a chemical reaction that proceeds in a presence of a catalyst, the test method comprising:
a step of feeding a sample to be fed to the catalyst at a preset flow rate;
a step of adjusting a temperature of a plurality of reaction vessels each including a catalyst layer filled with the catalyst;
a step of connecting a feed flow path through which the sample is fed, to a feed destination reaction vessel selected from the plurality of reaction vessels; and
a step of connecting a sample flow path intended to collect the sample for analysis that has passed through the catalyst layer, to an outflow source reaction vessel from which the sample flows out of the catalyst layer;
wherein
the step of connecting the feed flow path and the step of connecting the sample flow path are conducted by switching the feed destination and outflow source reaction vessels, such that the reaction rate test is performed under at least three conditions having different residence times in the catalyst layer.

9. The test method according to claim 8, wherein
the step of connecting the feed flow path and the step of connecting the sample flow path are switched and conducted on at least three reaction vessels having different volumes of the catalyst layer from each other, such that the feed destination reaction vessel and the outflow source reaction vessel coincide with each other.

10. The test method according to claim 8, wherein
the step of adjusting the temperature of the reaction vessels is conducted while the reaction vessels are in an accommodated state inside a temperature adjusting chamber,
the test method further comprising: a step of using an upstream side temperature adjusting chamber and a downstream side temperature adjusting chamber each accommodating a plurality of the reaction vessels having different volumes of the catalyst layer from each other, and connecting an upstream side reaction vessel that is accommodated in the upstream side temperature adjusting chamber and through which the sample flows out of the catalyst layer, and a downstream side reaction vessel that is selected from the plurality of the reaction vessels accommodated in the downstream side temperature adjusting chamber and to which the sample flowing out of the upstream side reaction vessel is fed, and
a step of connecting the upstream side reaction vessel and the downstream side reaction vessel being conducted, in addition to the switching of the feed destination and outflow source reaction vessels in the step of connecting the feed flow path and the step of connecting the sample flow path.

11. The test method according to claim 8, wherein
the step of adjusting the temperature of the reaction vessels is conducted while a plurality of the reaction vessels having different volumes of the catalyst layer from each other is in an accommodated state inside a temperature adjusting chamber,
the test method further comprising:
a step of connecting one reaction vessel through which the sample flows out of the catalyst layer and another reaction vessel selected from the reaction vessels other than the one reaction vessel among the plurality of reaction vessels; and
a step of selecting an outflow destination of the sample from the one reaction vessel, between the sample flow path and the another reaction vessel, and
in the step of selecting, the step of connecting the sample flow path being conducted such that the one reaction vessel works as the outflow source reaction vessel when connection to the sample flow path is selected, and the step of connecting the sample flow path being conducted such that the another reaction vessel works as the outflow source reaction vessel when connection to the another reaction vessel is selected.

12. The test method according to claim 8, wherein
by conducting the step of connecting the feed flow path and the step of connecting the sample flow path, the step of connecting the feed flow path and the step of connecting the sample flow path for a next one of the feed destination reaction vessel and a next one of the outflow source reaction vessel are conducted after a preset settling time has elapsed since a feed of the sample to the feed destination reaction vessel is started and the sample flowing out of the outflow source reaction vessel via the sample flow path has been collected.

13. The test method according to claim 8, wherein
by conducting the step of connecting the feed flow path and the step of connecting the sample flow path, the step of connecting the feed flow path and the step of connecting the sample flow path for a next one of the feed destination reaction vessel and a next one of the outflow source reaction vessel are conducted after the sample flowing out of the outflow source reaction vessel via the sample flow path has been collected at each sampling period determined based on a preset rule since a feed of the sample from the feed flow path to the feed destination reaction vessel is started and a concentration change index of a focused component contained in the sample has become equal to or less than a preset threshold based on a result of concentration analysis performed on the focused component.

14. The test method according to claim 8, wherein
the step of connecting the feed flow path and the step of connecting the sample flow path for a next one of the feed destination reaction vessel and a next one of the outflow source reaction vessel are conducted after a feed of the sample to a preceding one of the feed destination reaction vessel is stopped.
